(19) United States
(12) Patent Application Publication
(10) Pub. No.: US 2026/0146459 A1
(43) Pub. Date: May 28, 2026

(54) SYSTEM AND METHOD FOR SUPPORTING AN INDIVIDUAL DURING MANUAL LABOR OPERATIONS

(71) Applicant: THE BOEING COMPANY, Arlington, VA (US)

(72) Inventors: Phillip Crothers, Melbourne (AU); Harshil Mukeshbhai Desai, Melbourne (AU); Nicholas Pearsall, Brisbane (AU); John Visser, Melbourne (AU)

(73) Assignee: THE BOEING COMPANY, Arlington, VA (US)

(21) Appl. No.: 18/956,786

(22) Filed: Nov. 22, 2024

(51) Int. Cl. E04G 1/24; B64F 5/10; E04G 5/00; E04G 5/10; E04G 5/14

(52) U.S. Cl. CPC E04G 1/24; E04G 5/006; E04G 5/10; E04G 5/14; B64F 5/10; E04G 2001/242

(57) ABSTRACT

A system includes a base. A platform is coupled to the base. A staircase is coupled to the base and the platform. The staircase includes one or more steps leading up to the platform. A head support includes a front cross beam connected to a first arm and a second arm. The first arm and the second arm are pivotally coupled to the platform. The head support is selectively moveable between an upright position in which the front cross beam is above the platform, and a deployed position in which the front cross beam is forward from a front end of the platform.

### FIELD OF THE DISCLOSURE

Examples of the present disclosure generally relate systems and methods for supporting individuals during manual labor operations.

### BACKGROUND OF THE DISCLOSURE

Complex systems, such as commercial aircraft, are manufactured over months, if not years. During the manufacturing process, individuals assemble various components, sub-systems, and the like. As can be appreciated, during manual labor operations, individuals may be disposed and remain in certain positions over extended periods of time. Such positions can be awkward and sometimes uncomfortable over long periods of time.

### SUMMARY OF THE DISCLOSURE

A need exists for a system and a method for supporting an individual during manual labor operations.

With that need in mind, certain examples of the present disclosure provide a system including a base. A platform is coupled to the base. A staircase is coupled to the base and the platform. The staircase includes one or more steps leading up to the platform. A head support includes a front cross beam connected to a first arm and a second arm. The first arm and the second arm are pivotally coupled to the platform. The head support is selectively moveable between an upright position in which the front cross beam is above the platform, and a deployed position in which the front cross beam is forward from a front end of the platform.

The staircase can also include side handrails. The system can also include one or more upright bracing beams extending between the base and one or both of the platform or the staircase.

In at least one example, the front cross beam includes a head-supporting cushion.

In at least one example, the platform includes a lumbar support, and a torso support extending forwardly from a front end of the lumbar support. The torso support can include inwardly canted front edges. The platform can also include a cushioning layer.

In at least one example, the platform includes a first side rail upwardly extending from a first side of the platform, and a second side rail upwardly extending from a second side of the platform. Each of the first side rail and the second side rail can include a support cushion.

In at least one example, the head support in the deployed position provides a work opening defined between the front cross beam, the first arm, the second arm, and the front end of the platform.

The platform can also include an expanded front pillow at the front end.

A length of each of the first arm and the second arm can be adjustable. A length of the platform can be adjustable.

In at least one example, the base includes a first floor beam, a second floor beam, and a rear cross beam connecting the first floor beam to the second floor beam. In at least one further example, the base also includes one or more rollers extending downwardly from one or more of the first floor beam, the second floor beam, or the rear cross beam. The one or more rollers are configured to rollingly support the system on a floor.

The system can also include one or more motors coupled to the one or more rollers. The system can also include a control unit in communication with the one or more motors. The control unit is configured to be engaged to control movement of the system.

Certain examples of the present disclosure provide a method including selectively moving the head support between an upright position in which the front cross beam is above the platform, and a deployed position in which the front cross beam is forward from a front end of the platform.

### BRIEF DESCRIPTION OF THE DRAWINGS

FIG. 1 illustrates a perspective side view of a system having a head support in an upright position, according to an example of the present disclosure.

FIG. 2 illustrates a perspective side view of the system having the head support in a deployed position.

FIG. 3 illustrates a perspective front view of the system having the head support in the upright position.

FIG. 4 illustrates a perspective front view of the system having the head support in the deployed position.

FIG. 5 illustrates a perspective rear view of the system having the head support in the upright position.

FIG. 6 illustrates a perspective rear view of the system having the head support in the deployed position.

FIG. 7 illustrates a perspective top view of the system having the head support in the upright position.

FIG. 8 illustrates a perspective top view of the system having the head support in the deployed position.

FIG. 9 illustrates a perspective top view of the head support in the deployed position in relation to a platform.

FIG. 10 illustrates a top view of the head support, according to an example of the present disclosure.

FIG. 11 illustrates a simplified side view of the platform, according to an example of the present disclosure.

FIG. 12 illustrates a simplified block diagram of the system, according to an example of the present disclosure.

FIG. 13 illustrates a perspective front side view of an individual supported on the system with the head support in the deployed position, according to an example of the present disclosure.

FIG. 14 illustrates a perspective front side view of an individual supported on the system with the head support in the upright position, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

As described herein, examples of the present disclosure provide a system and a method for supporting an individual during manual labor operations. The system provides an ergonomic support apparatus, including a torso support configured to ensure a torso of an individual is supported while in a horizontal orientation. The system also includes a head support configured to ensure that a head of the individual is supported while in the horizontal orientation, and also maintain an ergonomic head angle. The system also includes a lumbar support and cushion to ensure a back of the individual is supported in the horizontal orientation. In at least one example, the head support is pivotally mounted to enable the head support to be pivoted out of the way when not needed. The system can be height adjustable. The system can also include side rails. The components of the system cooperate to eliminate, minimize, or otherwise reduce a risk of musculoskeletal injury to the individual.

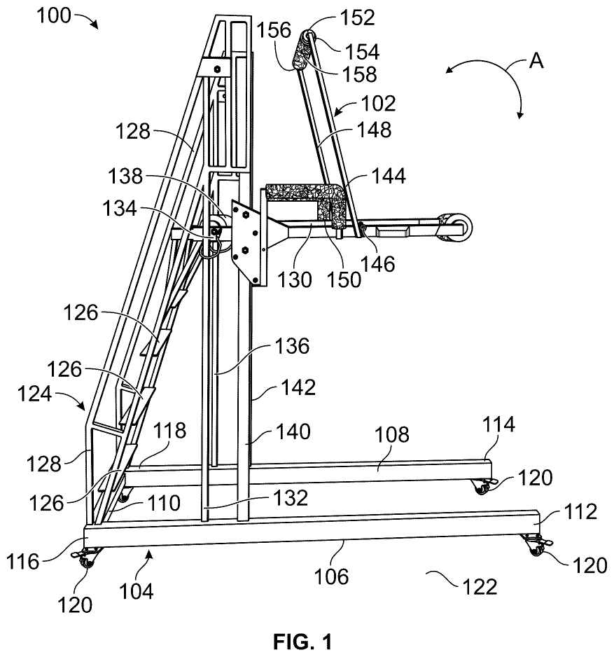

FIG. 1 illustrates a perspective side view of a system 100 having a head support 102 in an upright position, according to an example of the present disclosure. The system 100 includes a base 104 having a first floor beam 106 connected to a second floor beam 108 by a rear cross beam 110. The first floor beam 106 and the second floor beam 108 are parallel to one another, and perpendicular to the rear cross beam 110. Front ends 112 and 114 of the first floor beam 106 and the second floor beam 108, respectively, are free. For example, a cross beam does not connect the front ends 112 and 114. In contrast, rear ends 116 and 118 of the first floor beam 106 and the second floor beam 108 are connected by the rear cross beam 110. As such, the base 104 can be moved so that an object (such as a component being assembled) can fit between the first floor beam 106 and the second floor beam 108. Alternatively, a front cross beam can connect the front ends 112 and 114 together. Also, alternatively, instead of beams, the base 104 can include a flat panel, basin, and/or the like.

The base 104 also includes rollers 120, such as wheels, casters, or the like. The rollers 120 extends downwardly from the base 104 are rollingly support the system 100 on a floor 122. As shown, rollers 120 extend downwardly from the front end 112 of the first floor beam 106, the front end 114 of the second floor beam 108, the rear end 116 of the first floor beam 106, and the rear end 118 of the second floor beam 108. The rollers 120 allow the system 100 to be easily maneuvered to different locations over the floor 122. In at least one example, the rollers 120 are unpowered, and an individual pushes. pulls, and/or turns the system 100 to move the system 100 to different locations. As another example, one or more motors can be operatively coupled to the rollers 120, and configured to automatically move the system. In this example, a control unit can be in communication with the motors. The control unit can be secured to the system 100, or a remote handheld device. In at least one example, the platform 130 can further be configured to move vertically (such as up and down) in relation to the base 104), either manually, or automatically via one or more motors being coupled to the platform 130 and/or the base 104.

The system 100 also includes a staircase 124 extending upwardly from the rear cross beam 110 and/or the rear ends 116 and 118 of the first floor beam 106 and the second floor beam 108, respectively. The staircase 124 includes a plurality of steps 126 and side handrails 128. The steps 126 lead upwardly to a platform 130. The side handrails 128 provide structure for an individual to grasp while stepping up on the steps 126, as well as provide lateral barriers that reduce a risk of an individual falling off the staircase 124. The staircase 124 can include more or fewer steps 126 than shown.

A first upright bracing beam 132 extends upwardly from the first floor beam 106 to a rear side 134 of the platform 130, while a second upright bracing beam 136 extends upwardly from the second floor beam 108 to a rear side 138 of the platform 130. The first upright bracing beam 132 and the second upright bracing beam 136 are vertical rods, columns, panels, straps, and/or the like that provide bracing support to the platform 130 (and the staircase 124). The first upright bracing beam 132 and the second upright bracing beam 136 are orthogonal to the first floor beam 106 and the second floor beam 108.

A third upright bracing beam 140 extends upwardly from the first floor beam 106 forward from the first upright bracing beam 132 and also connects to the platform 130. Similarly, a fourth upright bracing beam 142 extends upwardly from the second floor beam 108 forward from the second upright bracing beam 136, and also connects to the platform 130. The third upright bracing beam 140 and the fourth upright bracing beam 142 are also vertical rods, columns, panels, straps, and/or the like that provide additional bracing support to the platform 130. The third upright bracing beam 140 and the fourth upright bracing beam 142 are parallel with the first upright bracing beam 132 and the second upright bracing beam 136. More or fewer upright bracing beams can be used. For example, additional bracing beams can extend between forward sections of the platform 130 and the first floor beam 106 and the second floor beam 108. As another example, the system 100 may not include the third upright bracing beam 140 or the fourth upright bracing beam 142.

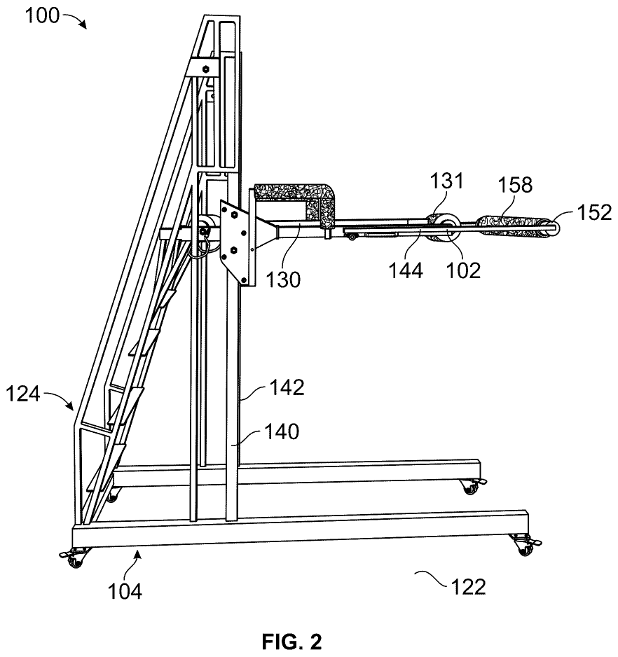

The system 100 includes the head support 102. As shown in FIG. 1, the head support 102 is in an upright position. The head support 102 includes a first arm 144 pivotally coupled to a first side 146 of the platform 130, a second arm 148 pivotally coupled to a second side 150 of the platform 130, and a front cross beam 152 that connects a front end 154 of the first arm 144 to a front end 156 of the second arm 148. In at least one example, the front cross beam 152 includes a head-supporting cushion 158 wrapped therearound. The head-supporting cushion 158 can be formed of a flexible, cushioning material, such as open-cell foam, closed cell foam, an elastomeric material such as rubber, and/or the like. In operation, the head support 102 is configured to be pivoted in the directions of arc A between the upright position (shown in FIG. 1), and a deployed position (shown in FIG. 2).

FIG. 2 illustrates a perspective side view of the system having the head support 102 in the deployed position. As shown, the system 100 is supported on the floor 122 by the base 104, such that the platform 130 is substantially (such as +/−5 degrees) parallel with a plane of the floor 122. In the deployed position, the head support 102 extends forwardly from the platform 130, and is generally parallel with an upper surface of the platform 130. The platform 130 and/or the head support 102 can include one or more stops (such as blocks, clamps, and/or the like) that prevent the head support 102 from pivoting below a parallel orientation with the platform 130.

As described herein, the system 100 is configured to support an individual, such as during a manual labor operation. The system 100 includes the base 104. The staircase 124 is coupled to the base 104. The platform 130 is coupled to the staircase 124 and the base 104. The staircase 124 includes one or more steps 126 leading up to the platform 130. The head support 102 includes the front cross beam 152 connected to the first arm 144 and the second arm 148, which are pivotally coupled to the platform 130. The head support 102 is selectively moveable between the upright position in which the front cross beam 152 is above the platform 130, and the deployed position in which the front cross beam 152 is forward from the front end 131 of the platform 130.

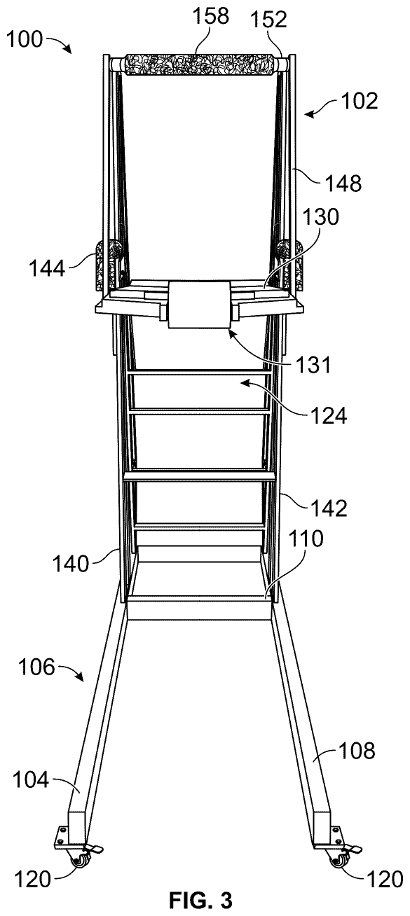

FIG. 3 illustrates a perspective front view of the system 100 having the head support 102 in the upright position. As shown, in the upright position, the head support 102 is pivoted upwardly, so that the front cross beam 152 is disposed above the platform 130.

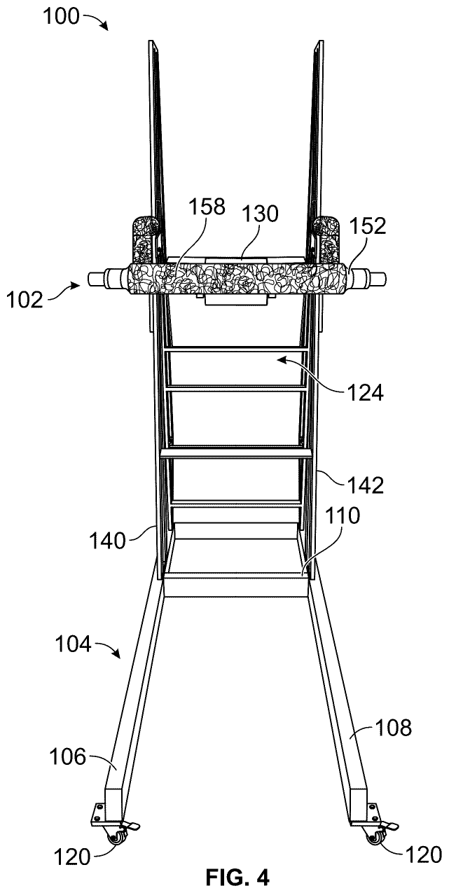

FIG. 4 illustrates a perspective front view of the system 100 having the head support 102 in the deployed position. In the deployed position, the head support 102 is pivoted into a forward position, such that the front cross beam 152 is forward from a front end 131 (shown in FIG. 3) of the platform 130.

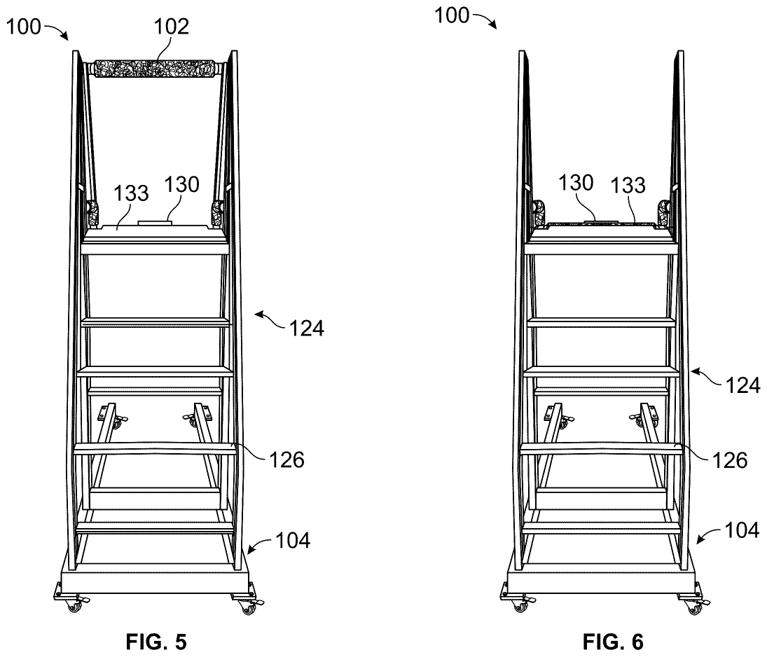

FIG. 5 illustrates a perspective rear view of the system having the head support 102 in the upright position. As shown, the front cross beam 152 in the upright position is disposed above a top surface 133 of the platform 130.

FIG. 6 illustrates a perspective rear view of the system 100 having the head support 102 (hidden from view in FIG. 6) in the deployed position. Referring to FIGS. 2, 4, and 6, in the deployed position, the front cross beam 152 is forward from the front end 131 of the platform 130.

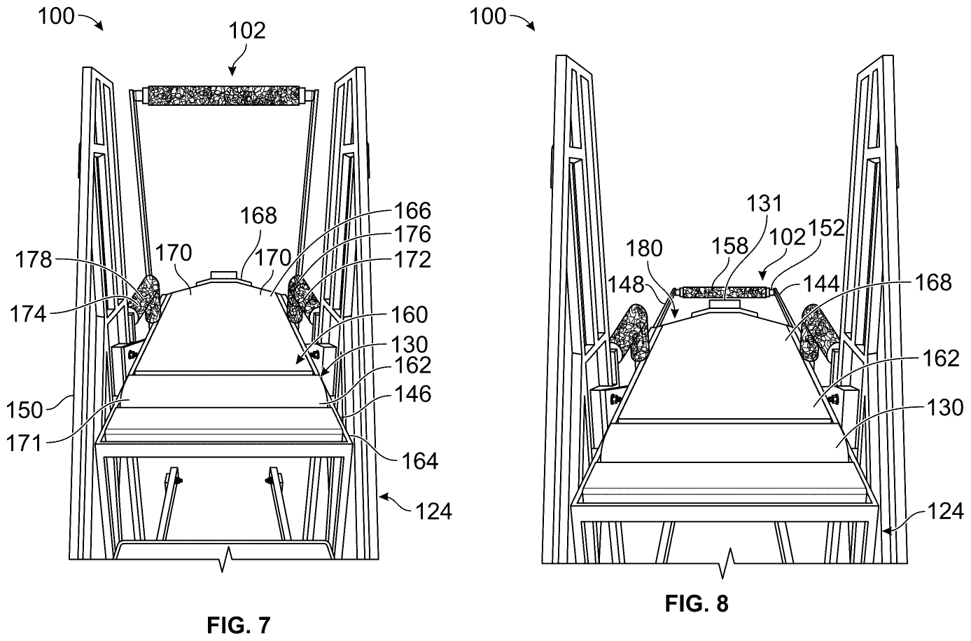

FIG. 7 illustrates a perspective top view of the system 100 having the head support 102 in the upright position. The platform 130 includes a bed 160 including a lumbar support 162, which extends from a rear end 164 toward a front end 166. A torso support 168 extends forwardly from the front end 166 of the lumbar support 162. In at least one example, the torso support 168 includes inwardly canted front edges 170, which are configured to allow an individual to comfortably hang arms thereover, if desired, in order to provide increased maneuverability and comfort during manual labor operations. The lumbar support 162 is configured to provide support to a lower torso and back of an individual during manual labor operations. The torso support 168 is configured to provide support to an upper torso of an individual during manual labor operations.

The platform 130, including the lumbar support 162 and the torso support 168, can include a cushioning layer 171, such as formed of open cell foam, closed cell foam, an elastomeric material, and/or the like, The cushioning layer 171 provides a comfortable surface on which an individual is supported.

The platform 130 also includes a first side rail 172 upwardly extending from the first side 146 of the platform 130, and a second side rail 174 upwardly extending from the second side 150 of the platform 130. The first side rail 172 and the second side rail 174 can extend along an entire length of the lumbar support 162. Optionally, the first side rail 172 and the second side rail 174 can extend along less than the entire length of the lumbar support 162. Further, the first side rail 172 and the second side rail 174 can include support cushions 176 and 178, respectively, wrapped around beams. The support cushions 176 and 178 can be formed of a closed cell foam, an open cell foam, an elastomeric material, and/or the like. The first side rail 172 and the second side rail 174 provide restraints that prevent an individual from laterally sliding off the platform 130.

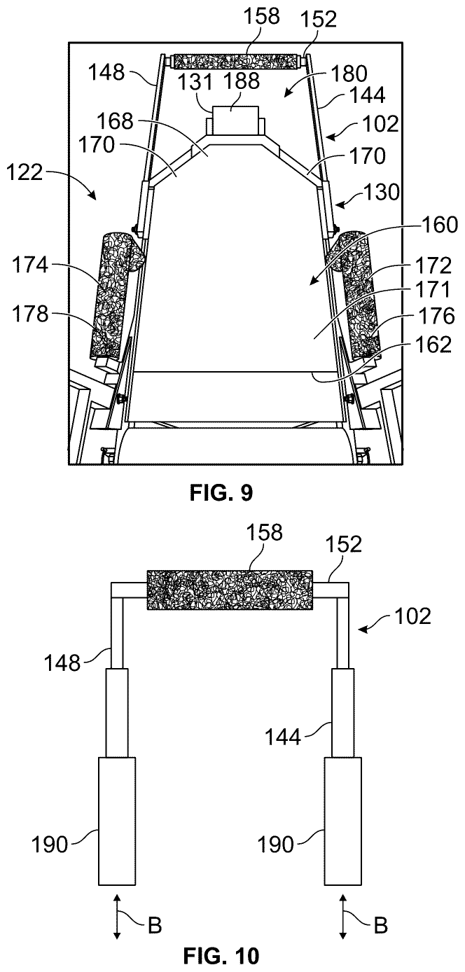

FIG. 8 illustrates a perspective top view of the system 100 having the head support 102 in the deployed position. FIG. 9 illustrates a perspective top view of the head support 102 in the deployed position in relation to the platform. 130. Referring to FIGS. 8 and 9, as shown, the head support 102 in the deployed position provides the head-supporting cushion 158 forwardly from the front end 131 of the platform 130. The first arm 144 and the second arm 148 are disposed on opposite sides of the platform 130. As such, in the deployed position, the head support 102 provides a work opening 180 defined between the front cross beam 152 (including the head-supporting cushion 158), the first arm 144, the second arm 148, and the front end 131 of the platform 130. In this manner, an individual can rest his/her forehead on the head-supporting cushion 158, which supports the weight of the head, with an upper torso supported by the torso support 168 and a lower torso supported by the lumbar support 162, and work on various structures, components, and the like through the work opening 180.

In at least one example, the platform 130 is configured to be substantially parallel (such as +/−5 degrees) to a plane of the floor 122. Optionally, the platform 130 can be pivotally coupled to one or more of the staircase 124 and/or upright support beams to allow the platform 130 to be adjusted into different planes in relation to the plane of the floor.

As shown in FIG. 9, in particular, the platform 130 can further include an expanded front pillow 188 at the front end 131 of the platform 130. The expanded front pillow 188 can forwardly extend from the torso support 168. The expanded front pillow 188 can extend above a plane of the remainder of the platform 130. The expanded front pillow 188 can be configured to provide support to a chin, neck, or the like of an individual laying on the platform 130. Optionally, the platform 130 may not include the expanded front pillow 188.

FIG. 10 illustrates a top view of the head support 102, according to an example of the present disclosure. In at least one example, the first arm 144 and the second arm 148 can include telescoping portions 190, which allow the first arm 144 and the second arm 148 to telescope outwardly and inwardly in the directions of arrows B. In this manner, a length of the head support 102 can be adjusted to a desired length to accommodate individuals of different heights. Optionally, lengths of the first arm 144 and the second arm 148 can be adjusted through different mechanism, such as articulating or pivoting portions, tracks, and/or the like. Optionally, lengths of the first arm 144 and the second arm 148 may not be adjustable.

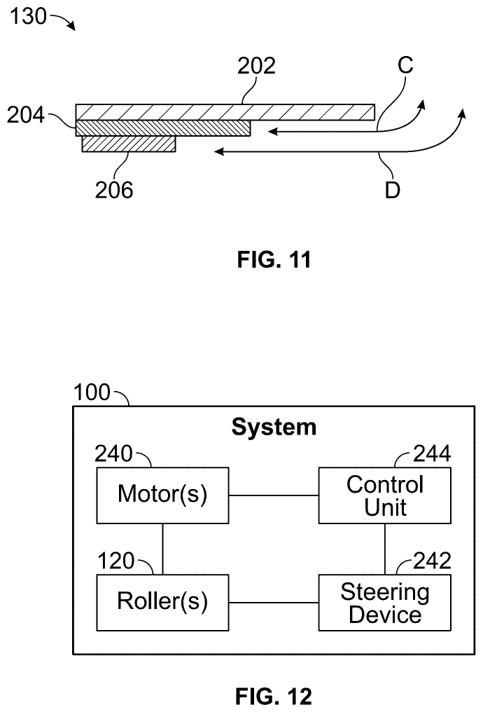

FIG. 11 illustrates a simplified side view of the platform 130, according to an example of the present disclosure. In at least one example, the platform 130 includes a plurality of panels 202, 204, and 206, which can be selectively slide in relation to one another, such as on tracks, in the directions of arrows C and D to allow a length of the platform 130 to be selectively adjusted to accommodate individuals of different heights. The panels 202, 204, and 206 can be slidably coupled together via one or more tracks, and one or more springs can be used to spring-bias extended panels 204 and 206 to be in a same plane as the panel 202. Optionally, the platform 130 can include telescoping portions that are configured to telescope inwardly and outwardly in relation to one another. Optionally, a length of the platform 130 may not be adjustable.

FIG. 12 illustrates a simplified block diagram of the system 100, according to an example of the present disclosure. In at least one example, one or more motors 240 (such as electric motors) can be operatively coupled to one or more of the rollers 120 to provide automatic movement. A steering device 242 (such as one or more of a rack(s), pinion(s), axle(s), gear(s), and/or the like) are also coupled to the roller(s) 120 to provide steering of the system 100. A control unit 244 is in communication with the motor(s) 240 and the steering device 242, such as through one or more wired or wireless connections. The control unit 244 is configured to be engaged by an individual to control automated motion of the system 100.

In at least one example, the control unit 244 is secured to the system 100, such as on the platform 130. As another example, the control unit 244 is a handheld device, such as a remote control. The control unit 244 can include one or more of a joystick, buttons, switches, a touchscreen interface, and/or the like configured to be engaged to control operation of the motor(s) 240 and the steering device 242. Optionally, the system 100 may not include a control unit, motor(s), or a steering device.

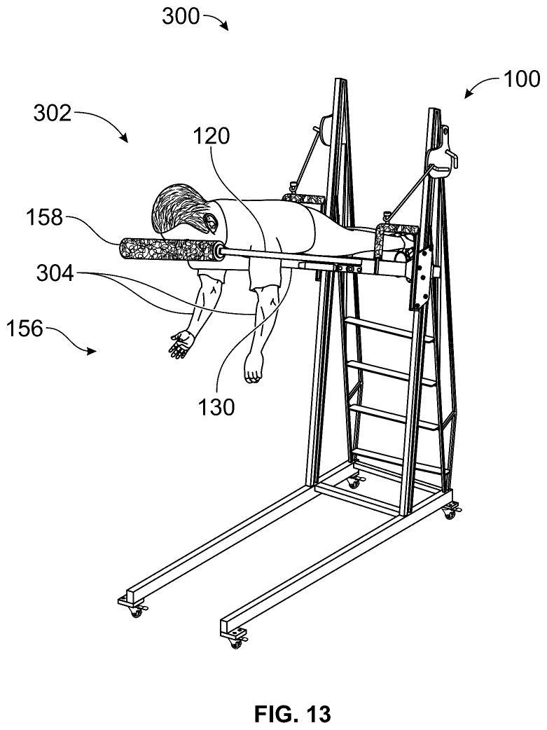

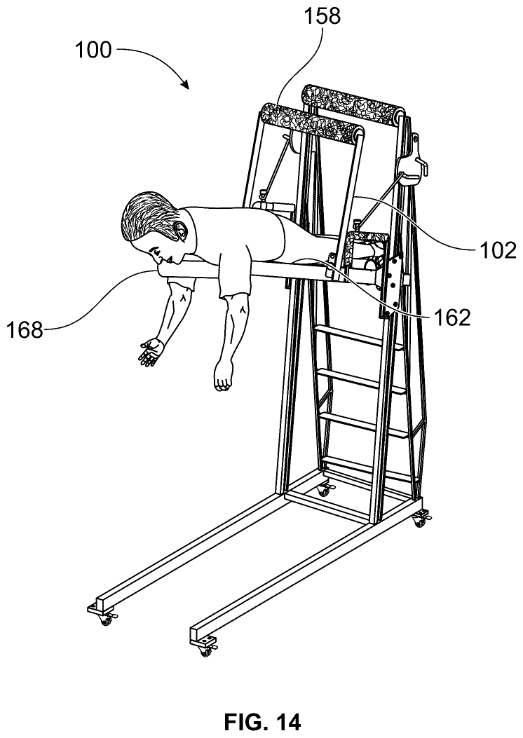

FIG. 13 illustrates a perspective front side view of an individual 300 supported on the system 100 with the head support 102 in the deployed position, according to an example of the present disclosure. As shown, the individual lays on the platform 130, with a forehead 302 supported on the head-supporting cushion 158. The individual 300 can see through the work opening 180 (shown in FIG. 9), and can extend arms 304 into and through the work opening 180 to operate on a structure.

FIG. 14 illustrates a perspective front side view of the individual 300 supported on the system 100 with the head support 102 in the upright position, according to an example of the present disclosure. When the head support 102 is pivoted into the upright position, the platform 130 (including the torso support 168 and the lumbar support 162) continues to comfortably support the individual in a horizontal position. The head support 102 can be moved into the upright position when not needed by the individual 300.

Further, the disclosure includes examples according to the following clauses:

Clause 1. A system comprising:
a base;
a platform coupled to the base;
a staircase coupled to the base and the platform, wherein the staircase includes one or more steps leading up to the platform; and
a head support including a front cross beam connected to a first arm and a second arm, wherein the first arm and the second arm are pivotally coupled to the platform, and wherein the head support is selectively moveable between an upright position in which the front cross beam is above the platform, and a deployed position in which the front cross beam is forward from a front end of the platform.

Clause 2. The system of Clause 1, wherein the staircase further comprises side handrails.

Clause 3. The system of Clauses 1 or 2, further comprising one or more upright bracing beams extending between the base and one or both of the platform or the staircase.

Clause 4. The system of any of Clauses 1-3, wherein the front cross beam comprises a head-supporting cushion.

Clause 5. The system of any of Clauses 1-4, wherein the platform comprises:
a lumbar support; and
a torso support extending forwardly from a front end of the lumbar support.

Clause 6. The system of Clause 5, wherein the torso support includes inwardly canted front edges.

Clause 7. The system of any of Clauses 1-6, wherein the platform comprises a cushioning layer.

Clause 8. The system of any of Clauses 1-7, wherein the platform comprises:
a first side rail upwardly extending from a first side of the platform; and
a second side rail upwardly extending from a second side of the platform.

Clause 9. The system of Clause 8, wherein each of the first side rail and the second side rail includes a support cushion.

Clause 10. The system of any of Clauses 1-9, wherein the head support in the deployed position provides a work opening defined between the front cross beam, the first arm, the second arm, and the front end of the platform.

Clause 11. The system of any of Clauses 1-10, wherein the platform comprises an expanded front pillow at the front end.

Clause 12. The system of any of Clauses 1-11, wherein a length of each of the first arm and the second arm is adjustable.

Clause 13. The system of any of Clauses 1-12, wherein a length of the platform is adjustable.

Clause 14. The system of any of Clauses 1-13, wherein the base comprises:
a first floor beam;
a second floor beam; and
a rear cross beam connecting the first floor beam to the second floor beam.

Clause 15. The system of Clause 14, wherein the base further comprises one or more rollers extending downwardly from one or more of the first floor beam, the second floor beam, or the rear cross beam, wherein the one or more rollers are configured to rollingly support the system on a floor.

Clause 16. The system of Clause 15, wherein further comprising one or more motors coupled to the one or more rollers.

Clause 17. The system of Clause 16, further comprising a control unit in communication with the one or more motors, wherein the control unit is configured to be engaged to control movement of the system.

Clause 18. A method for a system comprising:
a base;
a platform coupled to the base;
a staircase coupled to the base and the platform, wherein the staircase includes one or more steps leading up to the platform; and
a head support including a front cross beam connected to a first arm and a second arm, wherein the first arm and the second arm are pivotally coupled to the platform,
the method comprising:
selectively moving the head support between an upright position in which the front cross beam is above the platform, and a deployed position in which the front cross beam is forward from a front end of the platform.

Clause 19. A system comprising:
(a) a base comprising:
   a first floor beam;
   a second floor beam;
   a rear cross beam connecting the first floor beam to the second floor beam; and
   one or more rollers extending downwardly from one or more of the first floor beam, the second floor beam, or the rear cross beam, wherein the one or more rollers are configured to rollingly support the system on a floor;
(b) a platform coupled to the base, wherein the platform comprises:
   a lumbar support;
   a torso support extending forwardly from the lumbar support, wherein the torso support includes inwardly canted front edges, and wherein a cushioning layer extends over the lumbar support and the torso support;
   an expanded front pillow at a front end;
   a first side rail upwardly extending from a first side of the platform; and
   a second side rail upwardly extending from a second side of the platform, wherein each of the first side rail and the second side rail includes a support cushion;
(c) a staircase coupled to the base and the platform, wherein the staircase includes:
   one or more steps leading up to the platform; and
   side handrails;
(d) one or more upright bracing beams extending between the base and one or both of the platform or the staircase; and
(e) a head support comprising:
   a front cross beam including a head-supporting cushion;
   a first arm connected to the front cross beam; and
   a second arm connected to the front cross beam, wherein the first arm and the second arm are pivotally coupled to the platform, wherein the head support is selectively moveable between an upright position in which the front cross beam is above the platform, and a deployed position in which the front cross beam is forward from the front end of the platform, and wherein the head support in the deployed position provides a work opening defined between the front cross beam, the first arm, the second arm, and the front end of the platform.

Clause 20. The system of claim 19, further comprising:
one or more motors coupled to the one or more rollers; and
a control unit in communication with the one or more motors, wherein the control unit is configured to be engaged to control movement of the system.

As described herein, examples of the present disclosure provide a system and a method for supporting an individual during manual labor operations.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a base;
a platform coupled to the base;
a staircase coupled to the base and the platform, wherein the staircase includes one or more steps leading up to the platform; and
a head support including a front cross beam connected to a first arm and a second arm, wherein the first arm and the second arm are pivotally coupled to the platform, and wherein the head support is selectively moveable between an upright position in which the front cross beam is above the platform, and a deployed position in which the front cross beam is forward from a front end of the platform.

2. The system of claim 1, wherein the staircase further comprises side handrails.

3. The system of claim 1, further comprising one or more upright bracing beams extending between the base and one or both of the platform or the staircase.

4. The system of claim 1, wherein the front cross beam comprises a head-supporting cushion.

5. The system of claim 1, wherein the platform comprises:
a lumbar support; and
a torso support extending forwardly from a front end of the lumbar support.

6. The system of claim 5, wherein the torso support includes inwardly canted front edges.

7. The system of claim 1, wherein the platform comprises a cushioning layer.

8. The system of claim 1, wherein the platform comprises:
a first side rail upwardly extending from a first side of the platform; and
a second side rail upwardly extending from a second side of the platform.

9. The system of claim 8, wherein each of the first side rail and the second side rail includes a support cushion.

10. The system of claim 1, wherein the head support in the deployed position provides a work opening defined between the front cross beam, the first arm, the second arm, and the front end of the platform.

11. The system of claim 1, wherein the platform comprises an expanded front pillow at the front end.

12. The system of claim 1, wherein a length of each of the first arm and the second arm is adjustable.

13. The system of claim 1, wherein a length of the platform is adjustable.

14. The system of claim 1, wherein the base comprises:
a first floor beam;
a second floor beam; and
a rear cross beam connecting the first floor beam to the second floor beam.

15. The system of claim 14, wherein the base further comprises one or more rollers extending downwardly from one or more of the first floor beam, the second floor beam, or the rear cross beam, wherein the one or more rollers are configured to rollingly support the system on a floor.

16. The system of claim 15, wherein further comprising one or more motors coupled to the one or more rollers.

17. The system of claim 16, further comprising a control unit in communication with the one or more motors, wherein the control unit is configured to be engaged to control movement of the system.

18. A method for a system comprising:
a base;
a platform coupled to the base;
a staircase coupled to the base and the platform, wherein the staircase includes one or more steps leading up to the platform; and
a head support including a front cross beam connected to a first arm and a second arm, wherein the first arm and the second arm are pivotally coupled to the platform,
the method comprising:
selectively moving the head support between an upright position in which the front cross beam is above the platform, and a deployed position in which the front cross beam is forward from a front end of the platform.

19. A system comprising:
(a) a base comprising:
a first floor beam;
a second floor beam;
a rear cross beam connecting the first floor beam to the second floor beam; and
one or more rollers extending downwardly from one or more of the first floor beam, the second floor beam, or the rear cross beam, wherein the one or more rollers are configured to rollingly support the system on a floor;
(b) a platform coupled to the base, wherein the platform comprises:
a lumbar support;
a torso support extending forwardly from the lumbar support, wherein the torso support includes inwardly canted front edges, and wherein a cushioning layer extends over the lumbar support and the torso support;
an expanded front pillow at a front end;
a first side rail upwardly extending from a first side of the platform; and
a second side rail upwardly extending from a second side of the platform, wherein each of the first side rail and the second side rail includes a support cushion;
(c) a staircase coupled to the base and the platform, wherein the staircase includes:
one or more steps leading up to the platform; and
side handrails;
(d) one or more upright bracing beams extending between the base and one or both of the platform or the staircase; and
(e) a head support comprising:
a front cross beam including a head-supporting cushion;
a first arm connected to the front cross beam; and
a second arm connected to the front cross beam, wherein the first arm and the second arm are pivotally coupled to the platform, wherein the head support is selectively moveable between an upright position in which the front cross beam is above the platform, and a deployed position in which the front cross beam is forward from the front end of the platform, and wherein the head support in the deployed position provides a work opening defined between the front cross beam, the first arm, the second arm, and the front end of the platform.

20. The system of claim 19, further comprising:
one or more motors coupled to the one or more rollers; and
a control unit in communication with the one or more motors, wherein the control unit is configured to be engaged to control movement of the system.
